(19) United States
(12) Patent Application Publication
(10) Pub. No.: US 2004/0001978 A1
(43) Pub. Date: Jan. 1, 2004

(54) Molten metal resistant fabrics

(76) Inventors: Yves Bader, Geneva (CH); Hamid M. Ghorashi, Midlothian, VA (US); Genevieve M. Laverty, Geneva (CH)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/187,557

(22) Filed: Jul. 1, 2002

(51) Int. Cl. B27N 9/00; D03D 15/00; D04B 1/14

(52) U.S. Cl. 428/920; 442/197; 442/301; 442/310; 442/415; 428/921; 428/902

(57) ABSTRACT

This invention is related to a protective fabric resistant to molten metals, comprising 10 to 40 percent by weight meta-aramid fiber, 30 to 50 percent by weight wool fiber, and at least 20 percent by weight flame-retardant viscose fiber. Such fabrics typically have a total weight in the range of 200 to 450 grams per square meter and preferably have a total weight in the range of 200 to 260 grams per square meter.

### BACKGROUND OF THE INVENTION

There is an ongoing need for protective apparel suitable for use by workers who are exposed to molten metal hazards. These hazards are present in different industries, for example, in iron foundries workers are exposed to molten iron, in the manufacture of aluminum workers are exposed to cryolite and molten aluminum, and in many different industries welders are exposed to molten welding slugs and molten metal drops. Molten metal resistant apparel, such as garments, aprons, and sleeves, should have exterior surfaces that do not ignite and continue to burn on contact with the molten metal, and the molten metal should not stick to the apparel. If the molten metal adheres to the garments, serious burn injuries may result.

A typical response to this molten metal threat has been to provide workers with protective apparel made from thick heavy weight fabric, essentially relying on having enough fabric material between the worker and the threat to prevent injury. Generally, the basis weight of such fabric is 350 grams/square meter and the fabric can range as high as 450 gram/square meter or higher to perform adequately. The addition of more naturally flame retardant fibers such as wool has allowed some reduction in the overall weight of the fabric. One fabric in the art is made from a blend of wool and flame retardant viscose fiber and weighs in the range of 250 grams/square meter. However, the conditions under which this fabric is used can be rather harsh and fabric durability is an issue. Since durability of the garment is key to protecting a worker, any improvement in tear resistance, abrasion resistance, or tensile strength of the fabric has real value. With increased durability also comes the need for improved laundry shrinkage.

Therefore, what is needed is lightweight fabrics that can defeat both a molten metal threat and have improved strength, abrasion, and tear properties for improved durability. Such fabrics with improved laundry shrinkage performance are especially desired.

WO 2000/00686 (Wynn et al.) discloses a fabric that is inherently fire retardant, woven from a first yarn of a fire resistant natural fiber such as wool or a blend of natural fiber and a fire resistant synthetic material such as viscose, the preferred ratio being 50:50; and a second yarn that is a blend of a second natural fiber such as cotton and a fire resistant synthetic material such as viscose, the preferred blend being 50:50. Preferably the fabric is woven such that one face of the fabric is woven solely or predominantly from the first yarn and the other face woven solely or predominantly from the second yarn.

GB 2011244 discloses a welding suit made from a neoprene-coated fabric made from high temperature resistant aromatic polyamide fibers. This suit requires high temperature adhesives and the seams must be covered with some type of rubber material.

### SUMMARY OF THE INVENTION

This invention is related to a protective fabric resistant to molten metals, comprising 10 to 40 percent by weight meta-aramid fiber, 30 to 50 percent by weight wool fiber, and at least 20 percent by weight flame-retardant viscose fiber. Such fabrics typically have a total weight in the range of 200 to 450 grams per square meter and preferably have a total weight in the range of 200 to 260 grams per square meter. The preferred the meta-aramid fiber is poly(meta-phenylene isophthalamide) staple fiber having an average cut length of 5 cm or greater and a preferred cut length of 10 to 15 cm. For antistatic performance, the fabric can have in addition up to 5 percent of an antistatic fiber.

This invention is also related to a protective fabric especially resistant to molten aluminum, comprising 10 to 28 percent by weight meta-aramid fiber, 36 to 45 percent by weight wool fiber, and 36 to 45 percent by weight flame-retardant viscose fiber. preferred fabric for molten aluminum is comprised of 20 percent by weight meta-aramid fiber, 40 percent by weight wool fiber, and 40 percent by weight flame-retardant viscose fiber.

This invention is also related to a protective fabric especially resistant to molten iron, comprising 10 to 40 percent by weight meta-aramid fiber, 30 to 50 percent by weight wool fiber, and 30 to 40 percent by weight flame-retardant viscose fiber. A preferred fabric for molten iron is comprised of equal parts by weight of meta-aramid fiber, wool fiber, and flame-retardant viscose fiber.

This invention is also related to a two-sided protective fabric resistant to molten metals, comprising a threat face comprising 40 to 60 weight percent wool and 60 to 40 weight percent flame retardant viscose, and an opposite face comprising 10 to 40 percent by weight meta-aramid fiber, 30 to 50 percent by weight wool fiber, and at least 20 percent by weight flame-retardant viscose fiber. The preferred construction of the threat face comprises equal parts by weight of wool and flame retardant viscose fiber. The preferred construction of the opposite face comprises equal parts by weight of meta-aramid, wool, and flame-retardant fiber. For antistatic performance, this fabric can also contain, in addition, up to 5 percent by weight of an antistatic fiber.

### DETAILED DESCRIPTION OF THE INVENTION

This invention is related to fabrics useful in protecting workers from molten metals, particularly molten aluminum and iron and metal drops and other molten welding material. These fabrics can be incorporated into protective garments, for example shirts, pants, coveralls, and coats, or in protective gear such as aprons, sleeves, gloves and the like. The fabrics of this invention shed the molten metal while having other attributes such as tear resistance and abrasion resistance, and can have improved tensile properties and improved resistance to laundry shrinkage. Fabrics that tend to fail molten metal tests tend to adhere to the molten metal.

The fabrics of this invention are comprised of wool, flame-retardant viscose fiber, and meta-aramid fiber. Wool fiber is well known in the art and is generally defined as the fleece from sheep, lambs and goats, and may include specialty fibers such as the hair from other species such as camel, alpaca, llama, and vicuna. Viscose fiber is a popular type of fiber made from viscose. Viscose is also well known in the art and is composed of regenerated cellulose that can be made, for example, by converting wood pulp or waste cotton into a soluble compound and extruding this compound into filaments. Viscose fiber is typically made flame retardant by the addition of inorganic additives derived from such things as phosphorous compounds into the solution and then spinning the viscose fiber with these additives.

The fabrics of this invention also include meta-aramid fibers. By aramid is meant a polyamide wherein at least 85% of the amide (—CONH—) linkages are attached directly to two aromatic rings. A meta-aramid is such a polyamide that contains a meta configuration. Additives can be used with the aramid and, in fact it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the meta-aramid most often used is poly(meta-phenylene isophthalamide (MPD-I). Fibers may be spun by dry or wet spinning using any number of processes, however, U.S. Pat. No. 3,063,966 and U.S. Pat. No. 5,667,743 are illustrative of useful processes for making fibers that could be used in this invention.

Fabrics of this invention incorporate 10 to 40 percent by weight meta-aramid fiber, 30 to 50 percent by weight wool fiber, and at least 20 percent by weight flame-retardant (FR) viscose fiber. It is believed that at least 10 percent of the meta-aramid fiber should be present to see the improvements in fabric durability. Such fabrics have at least one improved physical property, selected from the group of tensile strength, tear strength, and abrasion resistance, over equivalent wool/FR viscose fabrics. Fabrics having more than 40 percent by weight meta-aramid fiber tend to fail the tests for molten metal adhesion, that is, in general molten metal tends to adhere to aramid fiber and having a precise amount of aramid fiber is critical for the fabric of this invention. When fabrics are made with the desired compositions, the wool and FR viscose fibers work together to help shield the aramid fiber from the molten metal so that little or none of the metal adheres to the fabric.

The fabrics of this invention can be made from any number of non-woven or woven processes that can make durable fabrics. If woven from yarns, the fabric can have almost any weave, however 2×1 twill and plain weaves are preferred. The most useful fabrics have basis weights in the range of 200 to 450 gram per square meter, with a preferred basis weight of 200 to 260 grams per square meter for fabrics used in protective apparel. The fabrics can have, as an optional component, fibers or other additives that reduce the propensity for static buildup on the fabric. A preferred fiber for imparting this antistatic property is a sheath core fiber having a nylon sheath and a carbon core that can be added in amounts up to 5 percent by weight in the fabric. Suitable materials for supplying antistatic properties are described in U.S. Pat. No. 3,803,453 and U.S. Pat. No. 4,612,150.

For additional strength, durability, and especially laundry shrinkage of the fabric, it is desired that long staple meta-aramid fiber be used; that is, the average meta-aramid staple cut length should be 5 cm or greater, and an average staple cut length of 10 to 15 cm is preferred. As is well known in the art, the shorter cut lengths may be processed using conventional cotton system equipment, while the longer cut lengths are normally processed using worsted system equipment. The fabrics of this invention containing meta-aramid fiber having a staple length of greater than 8 cm have significantly improved tensile strength, tear strength, abrasion resistance, and laundry shrinkage over fabrics made with equal parts by weight of just wool and FR viscose fiber.

One embodiment of this invention is a fabric that can perform in molten aluminum and molten cryolite environments. Cryolite is an aluminum solution from which pure aluminum is extracted, and is more highly adherent to fabrics than molten aluminum and in general presents a more difficult protection problem. It has been found that a protective fabric especially resistant to molten aluminum or cryolite can be made comprising 10 to 28 percent by weight meta-aramid fiber, 36 to 45 percent by weight wool fiber, and 36 to 45 percent by weight flame-retardant viscose fiber. A preferred fabric for use with aluminum comprises 20 percent by weight meta-aramid fiber, 40 percent by weight wool fiber, and 40 percent by weight flame-retardant viscose fiber. The key percentage for aluminum is the meta-aramid content; concentrations above 28 percent by weight cause progressive adherence of the molten metal to the fabric and at 33 percent by weight the fabric will fail the accepted tests for aluminum/cryolite molten metal protection.

Another embodiment of this invention is a fabric that can perform in molten iron environments. Molten iron does not present as difficult a problem as molten aluminum and a protective fabric especially resistant to molten iron can be made comprising 10 to 40 percent by weight meta-aramid fiber, 30 to 50 percent by weight wool fiber, and 30 to 40 percent by weight flame-retardant viscose fiber. A preferred fabric for use with iron comprises essentially equal parts by weight meta-aramid fiber, wool fiber, and flame-retardant viscose fiber. Both the aluminum-resistant and the iron-resistant fabrics can include other fibers, such as antistatic fibers, so long as the performance is not appreciably diminished.

Another embodiment of this invention relates to two-faced fabrics that contain adequate amounts of meta-aramid fiber for improved durability properties but these amounts are not necessarily present in both the warp and fill directions of the fabric. Such fabrics have a threat face (that would become the outer face of the garment) that sheds the molten metal, and an opposite face (that would become the inner face of the garment) that contacts the worker or the worker's clothes. The preferred two-faced fabric is a satin weave fabric wherein the warp yarns and fill yarns have different compositions, however plain, twill, and ripstop fabrics can be used. In particular, it has been found that a protective fabric resistant to molten metals can be made having threat face yarns, or warp yarns, that are a blend comprising 40 to 60 weight percent wool and 60 to 40 weight percent flame retardant viscose, and having as the opposite face yarns, or fill yarns, a blend comprising 10 to 40 percent by weight meta-aramid fiber, 30 to 50 percent by weight wool fiber, and at least 20 percent by weight flame-retardant viscose fiber. In the preferred form, these two-faced fabrics have equal parts by weight of wool and FR viscose on the threat face and equal parts by weight of long staple meta-aramid, wool, and FR viscose fiber on the opposite face. Such fabrics provide a threat face that is highly resistant to molten metals, however such fabrics also incorporate meta-aramid fiber for improved laundry shrinkage, while shielding the meta-aramid from the threat. Preferably, these fabrics also have up to 5 percent by weight antistatic fiber.

### EXAMPLES

### Example 1

This example illustrates a fabric having no adhesion to molten metal and also having adequate physical properties that is also especially suited for use with molten aluminum and cryolite. From a supply of variable length staple wool fiber, staple generally having a 5 cm long staple length was obtained and stock dyed a navy blue color. Crimped flame-retardant viscose (FRV) fiber known as Lenzing FR, a regenerated cellulosic fiber incorporating a flame retardant phosphor- and sulfur-containing pigment, free from chlorine, having a staple cut length of approximately 5 cm, was also separately stock dyed a navy blue color. 40 percent by weight of the navy blue dyed wool staple fiber, 40 percent by weight of the navy blue dyed FRV staple fiber, and 20 percent by weight of a crimped undyed (natural color) poly (metaphenylene isophthalamide) (MPD-I) staple fiber, also having a cut length of 5 cm, were blended together by use of a staple picker to make an intimate blend of staple fibers. The blend of staple fibers were then ring spun into staple yarns using conventional cotton staple processing equipment. The staple yarns were then plied and treated with steam to stabilize the yarns. The resulting plied yarns had a cotton count of 24/2 or an approximate linear density of 450 denier (500 dtex). The yarns were woven into a 282 grams per square meter (8.3 ounces per square yard) 2×1 twill weave fabric. The unfinished fabric had a tensile strength in the warp and fill of 842 and 649 newtons, respectively, tear strength in the warp and fill of 32 and 36 newtons, respectively, and an abrasion resistance of 30000 cycles. This unfinished fabric had a washing shrinkage after 5 cycles of 9.3 percent and 6.1 percent in the warp and fill. This fabric passed the test for molten aluminum and cryolite protection, using ASTM 955 and EN 531:1995 Clause 6.6 using the test method EN 373:1993, and passed the test for motel iron protection using EN 531:1995 Clause 6.6 using the test method EN 373:1993. This was also tested using small hot iron metal drops per EN 470-1: 1995 Clause 6.2 Impact of molten metal drops using the test method EN 348: 1992, and passed.

### Example 2

This example illustrates the metal shedding performance of a fabric especially suited for aluminum as in Example 1 is independent of staple length. A 2×1 twill fabric was constructed in a manner similar to Example 1 except that the wool fiber used was a variable length staple wool fiber, the MPD-I fiber was a crimped fiber having a staple length of 8 to 12 cm, and a crimped FRV fiber having a staple length of 5 to 9 cm, and the fiber was processed into a spun yarn using conventional worsted spinning processing equipment. This fabric was tested as in Example 1 and also passed the molten metal tests.

### Example 3

This example illustrates the performance of a fabric of this invention that is especially suited for molten iron and welding slugs. Equal parts of variable length staple wool fiber having an average measured staple length of 7 cm, FRV staple fiber having a variable staple length in the range of 5 to 9 cm and an average measured staple length of 6.8 cm, and crimped poly (metaphenylene isophthalamide) (MPD-I) staple fiber, having a variable staple length in the range of 8 to 12 cm and an average measured staple length of 10 cm, were blended together via a combing process to make an intimate blend of staple fibers. The wool had been top dyed using a conventional acid dyeing procedure. The blend of staple fibers was then spun by the ring spinning process into staple yarns using conventional long staple worsted processing equipment. The staple yarns were then plied together on a two-step twisting process and treated with steam to stabilize the yarns. The resulting plied yarn had a linear density of 500 dtex. The yarns were woven into a 247 grams per square meter (7.3 ounces per square yard) 2×1 twill weave fabric having 28,0 ends/cm and 18,0 picks/cm with 165 cm width. The fabric was washed and then dried at 100° C. with maximum overfeed in the stenter frame to control fabric tension. The next step consisted in applying a fluorocarbon finish and fixing this finish at 150° C. The fabric was then sanforized. The finished fabric had 29 ends/cm and 20 picks/cm and the final weight increased to 260 grams per square meter (7.7 ounces per square yard) with a width of 160 cm. The table illustrates the performance of this fabric when compared to the prior art finished fabrics of 50/50 wool/FR viscose This fabric was also tested for dimensional change after washing and drying according to the Operating Procedure No: EFL-028 and to the standard ISO 5077. The measurements were made on the fabric according to the standard ISO 3750. The washing was done at a temperature of 60±3 degrees C. with a detergent of 1 gram/liter of non phosphate IEC reference detergent A, in a front loading horizontal drum machine (Type A) according to standard ISO 6330 (Procedure No. 2A) and to the Operating Procedure No. EFL-029. The sample was dried in a tumbling machine according to the standard ISO 6330 (Procedure E) and to the Operating Procedure EFL-029 at a temperature of 60 degrees C. After 8 consecutive cycles of (5 washes and 1 dry) , a total of 40 washing cycles and 8 drying cycles, the shrinkage of the fabric was 1.7 percent in the warp and 2.7 percent in the weft.

This fabric was tested against molten iron, according to the norm EN 531: 1995 Clause 6.6 Molten iron splash, using the test method EN 373: 1993. The pouring temperature was 1400±20 degrees C. from a height of 225±mm and the specimen was 75±degrees to the horizontal.

This fabric was also tested against welding slugs, according to the norm EN 470-1: 1995 Clause 6.2 Impact of molten metal drops using the test method EN 348: 1992. For this test the fabric is pre-treated with five cycles of washing according to ISO 6330: 1984 Procedure 2A (60° C.) followed by one cycle of tumble drying (max. 70° C. outlet temperature) according to ISO 6330: 1984 Procedure E. The test consists of measuring the number of drops required to raise the temperature of the sensor behind the fabric by 40° C. The fabric passed the requirements of more than 15 drops and performed well in the test versus molten iron and welding slugs, which confirmed this fabric provides useful protection against these metals even in this light weight category.

### Example 4

A fabric was constructed in a manner similar to Example 3 except that the fabric was first treated with Zirpro®, which is a flame retardant chemical, and then dyed navy blue. The Zirpro® process, is based on the exhaustion of negatively charged zirconium and titanium complexes on wool fibre. Specific agents used for this purpose are potassium hexafluoro zirconate, K₂ZrF₆ and potassium hexafluoro titanate, K₂TiF₆. The next step consisted in applying a fluorocarbon finish and fixing this finish at 150° C. Finally the fabric was not sanforised. The finished fabric weight was 245 grams per square meter (7.2 ounces per square yard). The performance of this fabric in the molten metal tests was essentially the same as in Example 3.

TABLE

| Item | Ex. 3 | Ex. 4 | Prior Art |
|---|---|---|---|
| Weight | | | |
| g/m² | 260 | 245 | 248 |
| oz/yd² | 7.7 | 7.2 | 7.3 |
| Tensile Strength | 1019/690 | 1012/673 | 676/610 |
| N (warp/fill) | | | |
| Tear Strength | 59/75 | 53/68 | 31/32 |
| N (warp/fill) | | | |
| Abrasion Resistance | 55300 | 59300 | 29000 |
| Cycles | | | |
| Washing shrinkage | 2.2/0.5 | 5.0/2.5 | 6.6/4.4 |
| 5 cycles | | | |
| % (warp/fill) | | | |

1. A protective fabric resistant to molten metals, comprising:
10 to 40 percent by weight meta-aramid fiber,
30 to 50 percent by weight wool fiber, and
at least 20 percent by weight flame-retardant viscose fiber.

2. The fabric of claim 1 wherein the fabric has a total weight in the range of 200 to 450 grams per square meter.

3. The fabric of claim 2 wherein the fabric has a total weight in the range of 200 to 260 grams per square meter.

4. The fabric of claim 1 wherein the meta-aramid fiber is poly(meta-phenylene isophthalamide) staple fiber having an average cut length of 5 cm or greater.

5. The fabric of claim 4 wherein the poly(meta-phenylene isophthalamide) staple fiber has an average cut length of 10 to 15 cm.

6. The fabric of claim 1 containing up to 5 percent by weight of an antistatic fiber.

7. A protective fabric especially resistant to molten aluminum and cryolite, comprising:
10 to 28 percent by weight meta-aramid fiber,
36 to 45 percent by weight wool fiber, and
36 to 45 percent by weight flame-retardant viscose fiber.

8. The protective fabric of claim 7 which comprises 20 percent by weight meta-aramid fiber, 40 percent by weight wool fiber, and 40 percent by weight flame-retardant viscose fiber.

9. A protective fabric especially resistant to molten iron, comprising:
10 to 40 percent by weight meta-aramid fiber,
30 to 50 percent by weight wool fiber, and
30 to 40 percent by weight flame-retardant viscose fiber.

10. The fabric of claim 9 which comprises essentially equal parts by weight of meta-aramid fiber, wool fiber, and flame-retardant viscose fiber.

11. A protective fabric resistant to molten metals, comprising: a threat face comprising:
40 to 60 weight percent wool and
60 to 40 weight percent flame retardant viscose, and
an opposite face comprising:
10 to 40 percent by weight meta-aramid fiber,
30 to 50 percent by weight wool fiber, and
at least 20 percent by weight flame-retardant viscose fiber.

12. The fabric of claim 11 wherein the threat face comprises equal parts by weight of wool and flame retardant viscose

13. The fabric of claim 11 wherein the opposite face comprises equal parts by weight of meta-aramid, wool, and flame-retardant fiber.

14. The fabric of claim 11 containing up to 5 percent by weight of an antistatic fiber.
